(19) United States
(12) Patent Application Publication
(10) Pub. No.: US 2006/0067546 A1
(43) Pub. Date: Mar. 30, 2006

(54) Device for encouraging hand wash compliance

(75) Inventors: Richard P. Lewis, Marietta, GA (US); Paul F. Tramontina, Alpharetta, GA (US); Kenneth Kaufman, Bradenton, FL (US); Cheryl L. York, Canton, GA (US)

Correspondence Address: DORITY & MANNING, P.A., POST OFFICE BOX 1449, GREENVILLE, SC, 29602-1449, US

(73) Assignee: KIMBERLY-CLARK WORLDWIDE, INC.

(21) Appl. No.: 11/215,362

(22) Filed: Aug. 30, 2005

Related U.S. Application Data
(63) Continuation-in-part of application No. 10/950,965, filed on Sep. 27, 2004.

(51) Int. Cl. G09F 27/00; H04R 1/02; G08B 23/00

(52) U.S. Cl. 381/124; 381/334; 340/573.1

(57) ABSTRACT

A device to encourage hand washing compliance in a facility such as a restroom includes a housing configured for detachably mounting on a support surface. An ambient light sensor is disposed relative to the housing to detect ambient light within the room. An audio device within the housing contains at least one audible hand washing compliance message track that is played over a speaker within the housing. A controller is in operable communication with the ambient light sensor and the audio device, and activates the device upon determining whether a threshold amount of ambient light is present in the room.

### RELATED APPLICATIONS

The present application is a Continuation-In-Part (CIP) application of U.S. application Ser. No. 10/950,965 filed on Nov. 27, 2004.

### FIELD OF THE INVENTION

The present invention relates generally to the field of devices or systems that automatically play a recorded message upon occurrence of a detected event, and particularly to devices that automatically encourage users to wash their hands.

### BACKGROUND OF THE INVENTION

The importance of washing ones hands after using a restroom, particularly public restrooms, is well understood and appreciated by medical and food handling industries, and the general public as a whole, for preventing the spread of illness and maintaining personal hygiene and cleanliness. Many diseases have been found to be transmittable due to non-compliance with proper hand washing techniques after using public toilet facilities. In the food service sector, it is required by law in many states that employees wash their hands prior to returning to work after use of a toilet facility.

For these reasons, the use of signs and placards containing written notices and messages to encourage persons to wash their hands is widespread. Unfortunately, such signs have become so commonplace that their existence is barely noticed and they are relatively ineffective in encouraging people to actually wash their hands. These signs go generally unheeded by the public.

Efforts have been made at devising more aggressive systems to encourage people to wash their hands. For example, U.S. Pat. No. 6,031,461 describes a system wherein the user of a toilet is automatically marked with a washable substance such as a dye, paint, or chalk, upon flushing the toilet. The person must then thoroughly wash their hands to remove the substance. This type of system will irritate many individuals and would be prone to vandalism in public restrooms.

U.S. Pat. Nos. 5,870,015 and 6,028,520 describe different audible message systems that are automatically actuated by sensing operation of the toilet. The systems require sensors of one type or another to be configured with each individual toilet, such sensors being in communication with a controller that plays a prerecorded message upon, for example, sensing that the toilet has been flushed. These type of systems are relatively complex in that each toilet must be configured with at least one sensor and the controller must be sophisticated enough to receive and process signals from numerous sources. Also, the sensors are generally visible to the person using the toilet and, thus, prone to abuse.

Other systems require the user to wear an indicator or badge that is activated if the person has not washed their hands at a required location. The badge gives an outwardly visible indication that the person has not complied with required hand washing techniques. Reference is made for example to U.S. Pat. Nos. 5,812,059 and 5,610,589. Such systems are obviously not suitable for general public restroom facilities.

U.S. Pat. No. 4,896,144 describes an audible or visible message system that is actuated upon opening a door to a restroom facility. The system may also be configured to lock the restroom door to prevent the person from leaving the facility until they have complied, or to issue a warning signal to a remote location.

There is still need in the industry for a relatively simple, inexpensive, and non-obtrusive device to encourage users of public restroom facilities to wash their hands.

### OBJECTS AND SUMMARY OF THE INVENTION

Objects and advantages of the invention will be set forth in part in the following description, or may be obvious from the description, or may be learned through practice of the invention.

The present invention relates to a device intended to encourage persons entering a room or facility to wash their hands. The device has particular use in public restrooms, but is in no way limited to such use. The device may be located in any room or facility wherein persons should wash their hands or perform some other desired or required function after or before performing an activity. For example, the device may be used in medical facilities, research labs, clean room manufacturing facilities, and so forth.

The device includes a housing having any manner of aesthetically pleasing shape and that is configured for detachably mounting on a support surface such as a wall, counter, cabinet, and so forth. Any number of mechanical or adhesive mounting devices may be used in this regard. The housing may include a base and a cover, the cover being removable from the base to provide access to internal components of the device and a battery compartment (if provided).

The device includes a sensor for detecting the amount of ambient light within the room where the device is located. This sensor may include, for example, an array of one or more photodiodes. The photodiodes may be calibrated to react to only a threshold amount of ambient light within the room. In this regard, it may be desired to locate the photodiodes relative to the housing such that their sensing direction is relatively unaffected by persons or events in the room. For example, the sensor may be disposed to “look” through a lens in a top portion of the housing towards the ceiling of the room. The ambient light sensor may also be located remote from the housing. In a particular embodiment, the photodiode generates an input signal to a control circuit, for example as an input to a microprocessor, to initiate playback of a message upon sufficient ambient light being detected. The ambient light sensor may also be used to initiate a reduced power mode for the internal control circuitry in the absence of a threshold level of ambient light in order to prolong battery life.

An audio storage/playback device within the housing contains one or more pre-recorded audible hand washing compliance message tracks. The storage device may be any conventional device, such as a tape device, CD player, an electronic storage or “voice” chip, such as a permanently programmed ROM chip or programmable RAM chip. Various such devices are well known in the art, and the present device is not limited to any particular type of storage or playback device. A speaker within the housing is in operable communication with the audio device for playback of the message track.

The audio device may be programmable by a maintenance technician or other individual for customized voice messages. For example, an internal microphone may be incorporated to allow direct input of a voice message. Other means to customize the messages include, for example, RF devices, hard wire input hook-ups, text-to-voice via a computer, hand held devices that mate with the device, and so forth. In an alternative embodiment, the message may be permanently preprogrammed onto a storage medium in the device.

A control circuit activates the audio device upon sufficient ambient light being detected in the room. The control circuit may include a programmable microprocessor for controlling the various functions of the device, or in a less complicated embodiment, the control circuit may be a hard wired integrated circuit board type of controller. The control circuit may be configured to simply play the message track according to a timed sequence so long as a signal from the photodiode indicates that sufficient ambient light is present. For example, the circuit may include an internal timing loop such that the message(s) are repeated with a desired “dwell” time between each message (i.e., a 30 second dwell time). In an alternate embodiment, an adjustment switch may be provided to vary the dwell time.

The device may also include a master switch that de-energizes the control circuit regardless of the amount of ambient light within the room. This switch is preferably conspicuously located on or within the housing, or requires a special tool to access or position the switch.

The device may be portable and battery powered, wherein a battery compartment is provided within the housing and is accessible by removing a cover from the housing. In an alternate embodiment, the device may be powered by an existing AC system and include an appropriate transformer. With this embodiment, the device may be permanently mounted and hard-wired into the facilitiy's AC power system. In still an alternate embodiment, the device may be configured for both AC and battery DC power. A switch may be provided to select between power sources, or the control circuit may be configured to detect whether AC power is available and automatically switch to AC power. Various power schemes may be used in this regard, and the present invention is not limited to any particular type of power distribution scheme.

The message tracks may be widely varied. In a relatively simple embodiment, a single message track is stored in the audio device and contains a single message that is repeated (with or without an appreciable dwell time) so long as sufficient ambient light is detected by the ambient light sensor. In an alternative embodiment, the message track may contain multiple messages that are played back in sequence. For example, the track may contain the message but in different languages. Alternately, the message track may contain messages of different content in the same or different languages.

In a particularly versatile embodiment, multiple message tracks are stored in the audio device and a selector switch is provided to select between the different message tracks. For example, one message track may contain one or more messages particularly suited for a female restroom, and a separate message track may contain one or more messages particularly suited for a male restroom. In another embodiment, one message track may contain one or more messages that politely remind users to wash their hands, and a separate message track may contain messages of a more aggressive or forceful nature. It should be appreciated that the content and intent of different message tracks may be widely varied within the scope and spirit of the invention.

As mentioned, in a more sophisticated embodiment, the control circuit may include a microprocessor that performs various control functions. For example, the microprocessor may include an internal clock and be programmed to sample and process the ambient light signal from the photodiode at a certain frequency determined by the clock. The ambient light signal is compared to a stored threshold value and the device is actuated by the microprocessor if the actual ambient light exceeds the threshold value. The microprocessor may be programmable so that various functions and the message tracks can be changed. The microprocessor may be programmed to switch between different message tracks, or messages within an individual track, according to a programmed sequence or at random. It should be appreciated that a microprocessor will allow for a great number of control features that are within the scope and spirit of the invention.

It may also be desirable to include any number of shutdown or hibernation features with the device. For example, even if a threshold amount of ambient light is present, it may not be desired for the device to play continuously. A “rest” period may be programmed into the controls so that the device plays for a certain period of time and is deactivated for a period of time.

With still a further embodiment of a device to encourage hand-washing compliance in accordance with the invention, an audio playback device is configured within the housing for processing and playback of a message track stored on a removable storage device. Various suitable playback devices are known and may be used in this embodiment. The removable storage device may be any conventional storage medium, including memory cards (e.g. flash memory cards) containing one or more message track files in any file format that can be processed by the playback device. A speaker is driven by the playback device to broadcast the message track. This embodiment may be desirable in that any number of the storage devices containing any combination of message tracks can be played by a single compliance device. The storage devices may be separately stored and readily interchanged by maintenance personnel. The storage devices may be reprogrammed at remote locations at any time to change or add additional message tracks, and a facility may maintain a library of the storage devices.

It should be appreciated that the storage devices and playback device are not limited by storage format, file type, or processor type. The devices may be analog or digital. In a cost effective embodiment, the playback device may be a relatively inexpensive digital playback device, with the storage devices containing the message tracks in any suitable digital file format.

In any of the embodiments of the hand wash compliance device, a sensor may be configured with the device to detect a threshold condition near the device prior to control circuitry initiating playback of the message track. As mentioned, this sensor may be a low power, passive device, such as an ambient light sensor or motion detector, that detects a threshold condition adjacent the device such that the control circuitry initiates playback of the message track only so long as the threshold condition has been detected. In alternate embodiments, the sensor may be an active device that detects the presence of individuals or events near the device. For example, the sensor may include an active IR or RF transmitter and receiver circuitry configured to detect movement or the presence of individuals near the device. Upon valid detections, the control circuitry initiates playback of the message track at a predetermined frequency and over a desired time period.

In an alternate embodiment, the device may include a first low power sensor, such as an ambient light sensor or motion detector, configured with the control circuitry to switch the device from a reduced power “rest” mode to a powered-up or “ready” state upon detection of a threshold condition adjacent the device. In this state, an additional sensor then initiates playback of the message track upon detection of an additional sensed condition near the device. For example, the additional sensor may be an active sensor, such as an IR or RF detector, that transmits and receives at a predetermined frequency in the ready state to detect the presence of an individual or other event near the device. The additional sensor can also be a passive sensor, such as a motion detector or ambient light sensor that detects a changed condition adjacent the device in the ready state. For example, the additional sensor may be an ambient light sensor that, in the ready state, detects slight changes (increase or decrease) in ambient light caused by the presence of individuals near the device. The control circuitry then initiates playback of the message track upon a valid detection from the additional sensor.

In still another embodiment of a device to encourage hand-washing compliance according to the invention, a removable electronics package is configured with the housing. The electronics package may include essentially all or a substantial portion of the electronic operating components such as the audio playback device, message track storage device, control circuitry, and the like. The package may be readily inserted into and removed from a receptacle in the housing where, once inserted, the package is in communication with the housing power supply (i.e., a battery compartment). A speaker(s) may be included with the electronics package or mounted permanently in the housing, whereas the package would also be connected to the speakers once inserted into the housing.

The housing may include a removable cover that, in a closed position, covers and prevents removal of the electronics package.

The electronics package may include an internal non-removable message storage device, such as a digital sound chip, or a removable storage device, such as a flash memory card.

The capability to remove and replace the complete electronics package may be desirable in that the devices can be serviced without the necessity of removing the housing from the monitored facility. An inventory of electronics packages may be maintained by a facility for quick change-out of packages when necessary.

The invention will be described in greater detail below by reference to one or more embodiments illustrated in the accompanying drawings.

### BRIEF DESCRIPTION OF THE DRAWINGS

FIG. 1 is a perspective view of an exemplary restroom facility utilizing an device according to the present invention;

FIG. 2 is a side perspective view of an embodiment of the device according to the invention;

FIG. 3 is a perspective view of the device of FIG. 2 with the cover removed;

FIG. 4 is a perspective view of an exemplary control circuit board that may be used with the device of the present invention;

FIG. 5 is a diagram of an exemplary control circuit for use with the device;

FIGS. 6A and 6B are perspective views of alternate embodiments of devices according to the invention;

FIG. 7 is a perspective view of still an additional embodiment according to the invention;

FIG. 8 is a perspective view of the device of FIG. 7 with the cover moved to an open position;

FIG. 9 is a perspective view of the device of FIG. 8 particularly illustrating the removable memory device; and

FIG. 10 is a perspective view of an alternate embodiment of the device particularly illustrating a removable electronics package.

### DETAILED DESCRIPTION

Reference will now be made in detail to embodiments of the invention, one or more examples of which are illustrated in the drawings. Each example is provided by way of explanation of the invention, and not meant as a limitation of the invention. For example, features illustrated or described as part of one embodiment, may be used with another embodiment, to yield still a further embodiment. It is intended that the present invention include modifications and variations to the embodiments described herein.

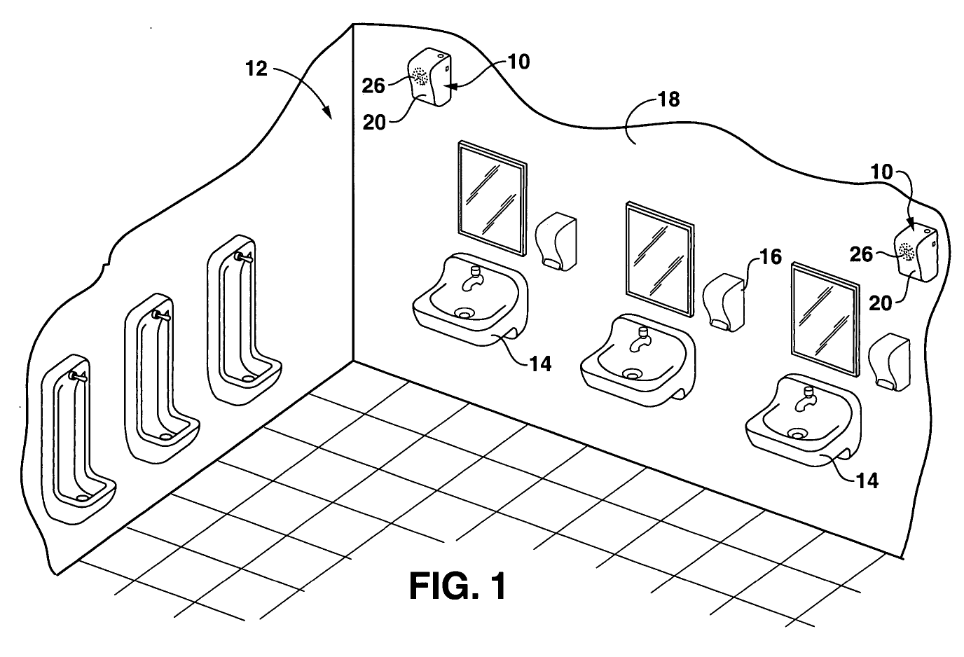

An embodiment of a device according to the invention for encouraging persons entering a room or facility to wash their hands is depicted generally as reference numeral 10 in the figures. Referring to FIG. 1, the device 10 is particularly useful in public restroom facilities 12 wherein hand washing stations including basins 14 and soap dispensers 16 are provided for persons to wash their hands after using the facilities. The device 10 is mounted at a suitable location on a support surface 18, such as a wall, counter, cabinet, and so forth. The device may be mounted by any conventional means, such as an adhesive, mechanical attaching devices, and so forth. Desirably, the device 10 is strategically mounted at a location within the facility 12 so as to be heard by persons using the facility. It may be desired to locate the device 10 at a height and location within the room 12 to deter vandalism. This may be accomplished simply by mounting the device 10 near the ceiling of the room 12.

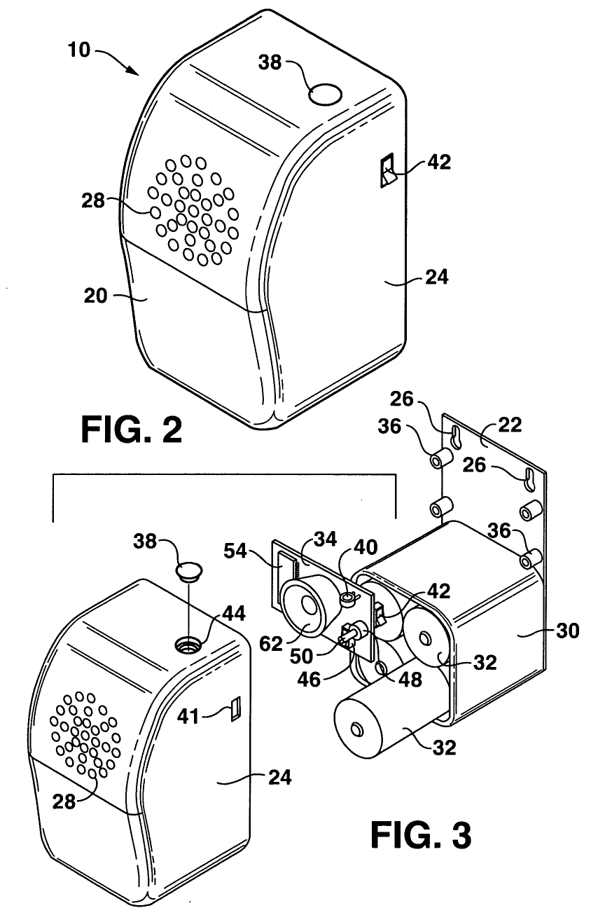

The device 10 includes a housing, generally 20, that may have any aesthetically pleasing shape and configuration, and may be made of any combination of conventional materials. Referring particularly to FIGS. 2 and 3, the housing 20 may include a base member 22 and a removable cover member 24. The base member 22 may include mounting holes 26, or any other suitable device or mechanism for mounting the housing 20 to the support surface, such as the wall 18 within the facility 12. The cover 24 is preferably removable from the base 22 in order to provide access to the internal components of the device 10. The cover 24 may be detachedly secured to the base 22 by any conventional means, including a latch mechanism, friction fit, detent mechanism, and so forth.

The cover 24 may include an array of holes 28 defined in an aesthetically pleasing pattern. The array 28 is located so that an audible message from a speaker 62 may be conveyed into the room 12 through the cover 24. In an alternate embodiment, a separate screen, wire grid, or other type of suitable speaker cover may be incorporated into the removable cover 24.

The device 10 includes a sensor for detecting the level of ambient light within the room or facility 12. In the illustrated embodiment, the ambient light sensor is at least on photodiode 40 (and may include an array of the photodiodes 40) disposed within the housing 20. The photodiode 40 detects ambient light through a lens 38 fitted into an opening 44 in the housing cover 24. Desirably, the photodiode 40 and associated lens 38 are positioned to detect the level of ambient light within the room 12 that is unaffected by persons or activity occurring within the room 12. For example, it would be undesirable for the amount of ambient light detected by the sensor 40 to vary by the number of persons or position of such persons within the room 12. Thus, in the illustrated embodiment, the detector 40 is oriented so as to “look” through the top portion of the removable cover 24 towards the ceiling of the facility 12.

The use of photodiodes in sensor systems to detect ambient light is well known by those skilled in the art and a detailed explanation of such devices is not necessary for purposes of the present description.

In an alternative embodiment not illustrated in the figures, the ambient light sensor may be a remotely located sensor. For example, one or an array of photodiodes may be remotely located with respect to the housing and in communication with control circuitry of the device 10 for conveying an ambient light signal to the circuitry. For example, the photodiode may be a plug-in component to the control circuitry board.

The photodiode 40 may be calibrated to react only to a threshold amount of ambient light within the room 12. In an alternate embodiment, the photodiode may transmit a signal indicative of any amount of ambient light detected within the room 12, this signal being compared by the control circuitry to a predetermined threshold value and, if the threshold value is exceeded the control circuitry will initiate playback of the stored audio message.

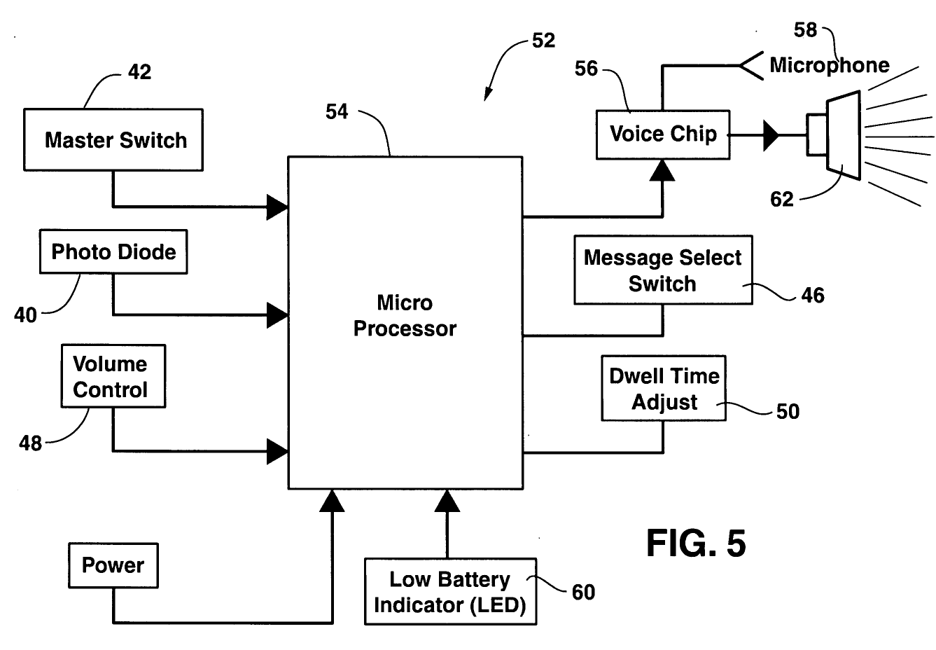

An audio storage/playback device is contained within the housing for storing one or more prerecorded audible hand washing compliance message tracks. The device 10 is not limited by any particular type of audio device. For example, such device may be a conventional tape device, CD player/recorder, and the like. In a particularly desirable embodiment, the audio device comprises an electronic storage “voice” chip 56 (FIG. 5). Any one or combination of hand washing messages are encoded in the chip 56 and are transmitted to a speaker 62 (with associated speaker driver) for subsequent delivery as an audible hand washing compliance message to persons within the facility 12. Such messages will be described in greater detail below.

In a particular embodiment, the voice chip 56 may be a ROM version that is pre-programmed at the point of manufacture of the device 10 with the desired message track(s). With this embodiment, the messages are permanently stored and cannot be altered. In an alternative embodiment, the voice chip 56 may be a RAM version and the control circuitry 52 (FIG. 5) may include a microphone 58 for customization and programmability of the RAM voice chip 56. Suitable voice chip audio devices include the ISD1020A device commercially available from Information Storage Devices, Inc. With this embodiment, the customization or recording of any number of voice messages is accomplished by the end user recording a personalized message via the microphone 58 and under the control of a microprocessor 54. The microphone 58 may be mounted within the housing 20 so as to be operationally accessible through the speaker hole array 28 in the cover 24. This message customization feature provides distinct advantages for enhancing the versatility and functionality of the device 10.

The device 10 also includes a control circuit for initiating and controlling playback of the stored message or messages. The control circuit components may be mounted to a circuit board 34 contained in the housing 20. In the illustrated embodiment, the circuit board 34 is mounted to the base 22 by way of mounting posts 36. In one embodiment, the control circuit need not include a microprocessor, but may include a hard wired integrated circuit wherein the control functions are executed by conventional logic circuits and chip devices. For example, such a control circuit may include an audio circuit incorporated as a single chip voice record/playback device, such as an ISD2560S device, or the VP1000 Quick Voice Device manufactured by Eletech Electronics, Inc. The audio device is actuated upon receipt of a control signal from the ambient light sensor (after appropriate filtering, amplification, and so forth).

In a particularly functional embodiment, the control circuitry 52 (FIG. 5) includes a programmable microprocessor 54. This microprocessor 54 may be, for example, a Microchip PIC16C505 device or PIC165C56 device commercially available from Microchip Technology, Inc. The microprocessor 54 responds directly to electrical or mechanical switch inputs from the various devices, as illustrated in FIG. 5 and explained in greater detail below. The microprocessor 54 can directly drive outputs, such as the voice chip 56 and speaker/speaker drive combination 62. A power amplifier may be added to enhance of the output functions of the microprocessor 54.

The microprocessor 54 includes any number of programmable I/O pins for additional functionality. For example, these pins may be used to provide selectability between various message tracks, as indicated by the message select switch 46 in FIG. 5. The microprocessor 54 may allow for manual adjustment of the dwell time between messages, as provided by the dwell time adjust mechanism 50. Similarly, a volume control device 48 may provide an input to the microprocessor 54 for adjusting the volume of the audio message.

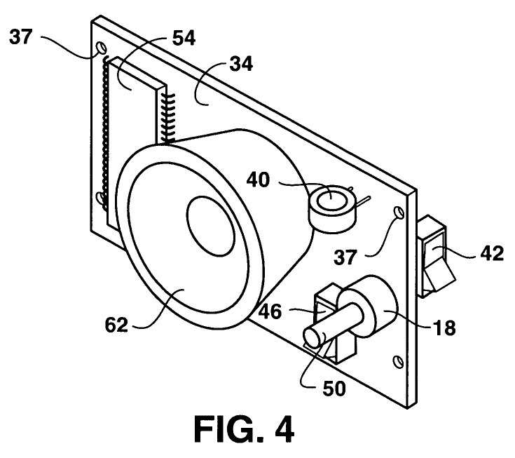

Referring particularly to FIGS. 2 through 5, the device 10 may include a master switch 42 that is accessible through an opening 41 in the housing cover 24. This switch may be conveniently located so that a maintenance technician can de-energize the device 10 regardless of the amount of ambient light within the room. The switch 42 may desirably be conspicuously located within the housing 20 so as to be unnoticeable or generally inaccessible by the public. For example, the switch 42 may be recessed within the housing and accessible via a special tool or other device inserted through the opening 41 in the housing cover 24. This configuration prevents unauthorized deactivation of the device.

The device 10 may be powered by any configuration of AC or DC power supply. For example, in the illustrated embodiment, the device 10 is generally portable and includes an internal battery compartment 30 in which batteries 32 are housed. The batteries 32 provide the power supply to the control circuitry, as illustrated in FIG. 5. In an alternative embodiment, the device 10 may be supplied by a facility's existing AC system. For example, the device 10 may be hardwired to the AC system and include an internal or external transformer to provide the necessary DC voltage for the control circuitry 52. In still an alternative embodiment, the device 10 may be configured to be supplied with DC power from an internal DC power source, such as the batteries 32, or via external AC power. A switch (not illustrated) may be provided to select between the desired power source.

A voltage detection circuit 60 may also be desired for detecting and providing an indication of low battery power. For example, the circuit may illuminate a visible LED in the event that battery power falls below a given voltage level.

As mentioned, the stored message tracks may vary considerably within the scope and spirit of the invention. The voice message can be of an animated character, a celebrity, in different languages, and so forth. The messages may be played by the microprocessor 54 according to a preprogrammed sequence, by random selection, and so forth. In this regard, the voice chip 56 has sufficient ROM or RAM memory for multiple messages, such messages being preprogrammed into a ROM memory or customized to a RAM memory. In a relatively simple embodiment of the invention, a single message track is stored on the voice chip 56 and is continuously repeated (with a selected dwell time between each message) so long as sufficient ambient light is detected by the photodiode 40. In an alternate embodiment, the message track may contain multiple messages that are played back in an alternating sequence. For example, a single message track may contain the same message in different languages. Alternately, a single message track may contain messages of different content in the same or different languages.

As mentioned, in a particularly versatile embodiment of the invention, multiple message tracks are stored on the voice chip 56 and accessible by the microprocessor 54. As mentioned, the message select switch 46 is provided so that a maintenance technician can select between desired message tracks. For example, one message track may contain one or more messages particularly suited for a female restroom, and a separate message track may contain one or more messages particularly suited for a male restroom. One message track may contain one or more messages that politely remind users to wash their hands, while a separate message track may contain one or more messages of a more aggressive or forceful nature. It should be appreciated that the content and intent of different message tracks may be widely varied within the scope and spirit of the invention.

It may be desired that the control circuitry 52 include an internal clock that may be utilized for various control functions. For example, the microprocessor 54 may sample the ambient light signal from the photodiode 40 at a frequency determined by the internal clock. The light signal may be compared to a stored threshold value and the device 10 being activated by the microprocessor 54 so long as the sampled ambient light signal exceeds the stored threshold value. This threshold value may be permanently programmed or stored in the microprocessor 54, or may be variable by a maintenance technician via an input to the microprocessor 54.

The message select switch 46 may also be configured to provide additional functionality to the sequence, number, and combination of messages stored in the voice chip 56. For example, the microprocessor may be programmed or programmable to switch between different message tracks, or messages within an individual message track, according to a programmed sequence, or in a random sequence. It should be appreciated that the microprocessor 54 allows for any combination of desirable functionalities within the scope and spirit of the invention.

The internal clock function described above may also be used to program a shutdown or hibernation feature for the device. For example, it may not be desired for the device 10 to continuously play a message in all situations where ambient light is present. In this regard, a “rest” period may be programmed into the circuitry 52 so that the device plays for a certain period of time and is deactivated for a remaining period of time. This may be the case, for example, wherein the device 10 is situated in a room or facility wherein ambient light is always present, but where it is not anticipated that users will be in the facility during certain times of the day.

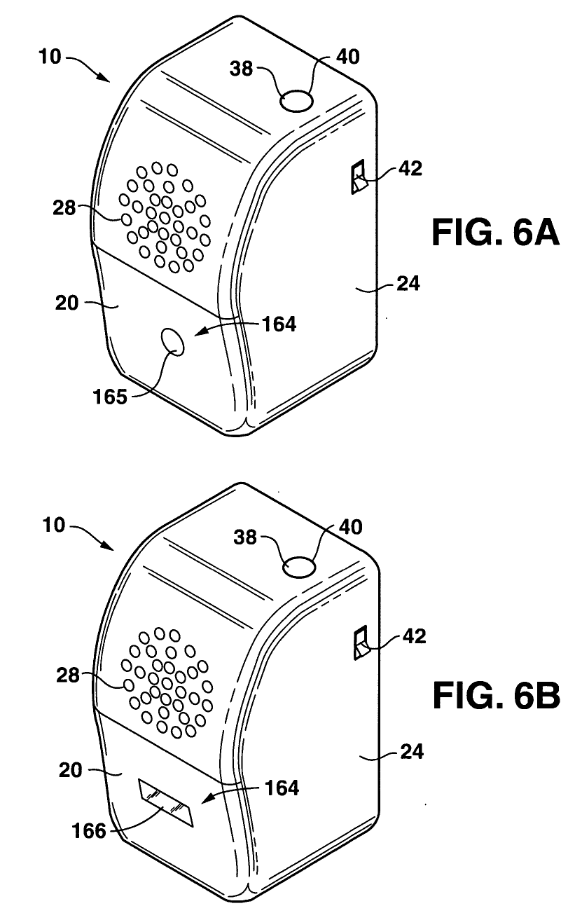

FIGS. 6A and 6B illustrate alternative embodiments of a hand wash compliance device 10 in accordance with the invention incorporating additional sensors to detect a threshold condition near the device 10 prior to the control circuitry initiating playback of the message track. For example, referring to FIG. 6A, an additional sensor 164 is provided within the housing 20 at an orientation to sense through the forward portion of the cover 24. In the illustrated embodiment, the additional sensor 164 is depicted as a relatively low power passive device, such as an additional ambient light sensor or motion detector 165. Suitable motion detectors are well known to those skilled in the art, and any commercially available motion detector may be employed for this purpose. If an ambient light sensor is utilized, then the sensor may have a detection threshold that is different from the ambient light sensor disposed so as to look through the lens 38 on the top of the cover 20, as discussed above. The additional ambient light sensor 165 may be calibrated so as to detect changes in ambient light (increase or decrease) around the device 10 as a result of persons in the restroom facility. It should be appreciated, however, that the additional sensor 165 does not cause a playback of a message unless the initial threshold amount of ambient light has been detected by the sensor 40, as discussed above.

It is also within the scope and spirit of the invention to include a single passive sensor, such as ambient light sensor 165, that initiates playback of a message upon detection of an event or condition adjacent the device 10, such as changes in ambient light or motion of a person near the device 10. This configuration may be preferred in that the single sensor will, in essence, place the device (and associated control circuitry) in a powered-down “rest” mode whenever the threshold condition is not detected. For example, a single ambient light sensor disposed so as to detect in front of the device 10, as with sensor 165 in FIG. 6A, will also shut the device 10 down when lights have been turned off in the monitored facility.

FIG. 6B illustrates an embodiment wherein the additional sensor 164 is depicted as an active sensor 166. This active sensor may be, for example, an active IR or RF transmitter with associated receiver circuitry. The use and operation of such devices is well known in the art. Upon valid detections from the active sensor 166, the control circuitry initiates playback of the message track. Again, this assumes that the initial threshold amount of ambient light has been detected by the sensor 40. In an alternate embodiment, the device 10 may be configured with a single sensor, which is an active sensor such as an IR or RF sensor.

It should be appreciated that the use of an additional sensor as discussed with respect to FIGS. 6A and 6B pertains to any embodiment of the device 10, 100 illustrated and described herein.

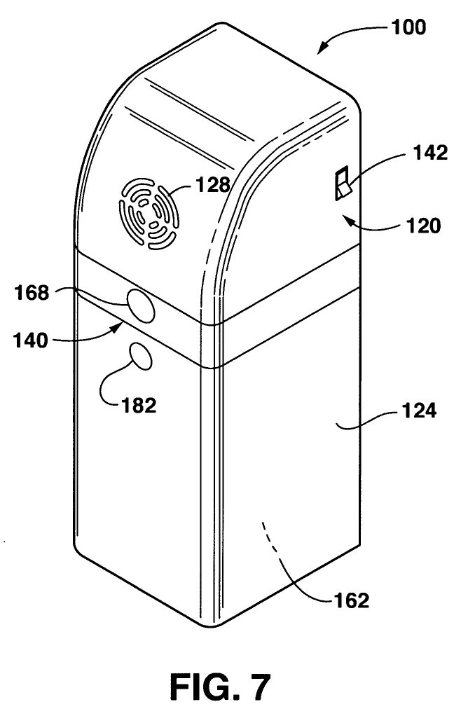

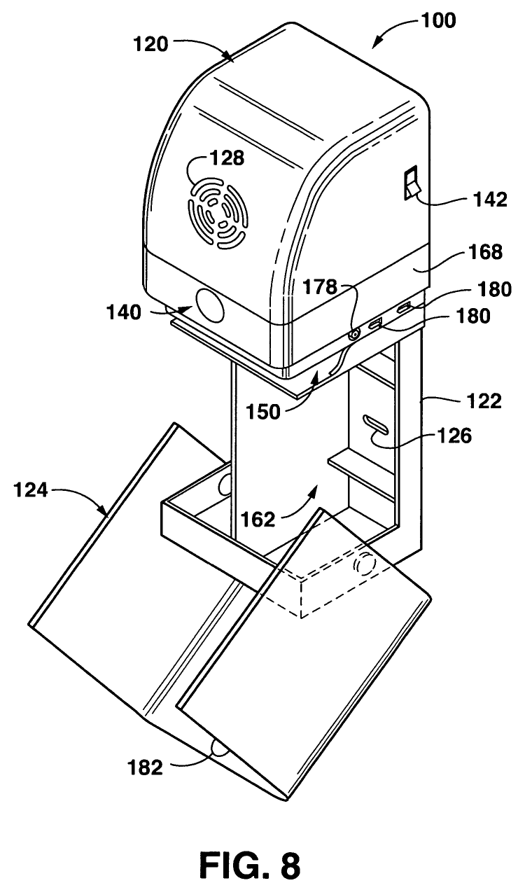

FIGS. 7 and 8 illustrate an alternative embodiment 100 of a hand wash compliance device according to the invention. With this embodiment, the housing 120 includes a base member 122 defining a relatively large battery compartment 162 as compared to the embodiment of, for example, FIGS. 6A and 6B. The battery capacity of the device 100 is substantially increased with the larger battery compartment 162. The base member 122 includes mounting holes 126 for mounting the device 100 to any suitable support surface. An array or grid of speaker holes 128 is provided at an appropriate location on the housing 120 with respect to an internal speaker. A cover member 124 is provided and can be removed or opened relative to the base member 122 for exposing the battery compartment 162, as well as certain electronic and control components as discussed in greater detail below. Any conventional locking mechanism 182 may be utilized to maintain the cover 124 in its closed position relative to the housing 120 and base member 122.

As with the other embodiments described herein, the device 100 may include a master switch 142 for completely deactivating the device 100.

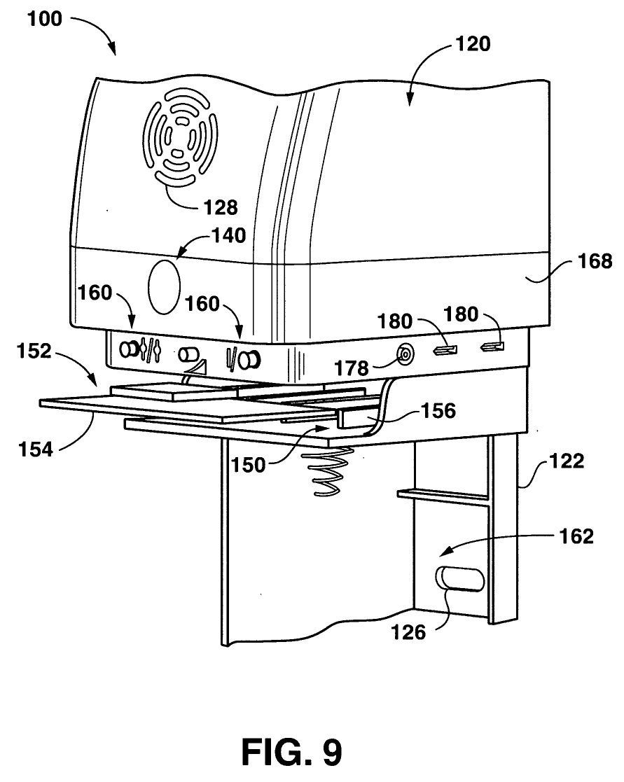

The device 100 also includes an internal audio playback device for processing and playback of a message track stored on a removable storage device. The removable storage device is depicted in FIG. 9 as a memory card 154. The audio playback device may be any conventional audio device configured for processing and playback of a saved audio file stored on the removable storage device 154. In a relatively cost effective embodiment, the audio playback device may be a relatively inexpensive digital playback device, with the storage device 154 containing the message tracks in any suitable digital file format, such as MP3 WMA, and so forth.

Referring to FIG. 9, removal of the cover 124 exposes a receptacle 150 for receipt of the removable storage device 154. In the illustrated embodiment, the storage device is a flash memory card 154 that slides along rails 156. In its operational inserted position, the memory card 154 electronically mates with the internal audio playback device. Any configuration of controls 160 may be provided for varying certain operational parameters of the device, for example dwell time, volume, message track selection, and so forth. Additionally, it may be desired to include any combination of communication ports or connections, such as the cable connection 178 or USB ports 180 for communicating with the internal audio playback device for any number of reasons, including initial or reprogramming of the device, download of operating files or message track files, and so forth.

It should be appreciated that the movable storage device 154 may be any manner of suitable storage medium that contains the desired number and combination of message tracks in a file format that is processed by the audio playback device. Memory cards, such as flash memory cards, may be particularly well suited for this application. It should also be appreciated that the storage devices and audio playback device are not limited by storage format, file type, or processor type. The devices may be analog or digital.

In the embodiment of FIGS. 7 through 9, the sensor 140 is illustrated as a forward-seeking sensor disposed to “look” through the front portion of the housing 120. This sensor 140 may be an active or passive sensor, as discussed above with respect to the other embodiments. As mentioned, an additional sensor (either active or passive) may also be included with the embodiment of FIGS. 7 through 9. This sensor may be a low power, passive device, such as an ambient light sensor or motion detector, that detects a condition adjacent the device 100. In alternative embodiments, the additional sensor may be an active device, such as an RF or IR sensor, that detects the presence of individuals or events near the device.

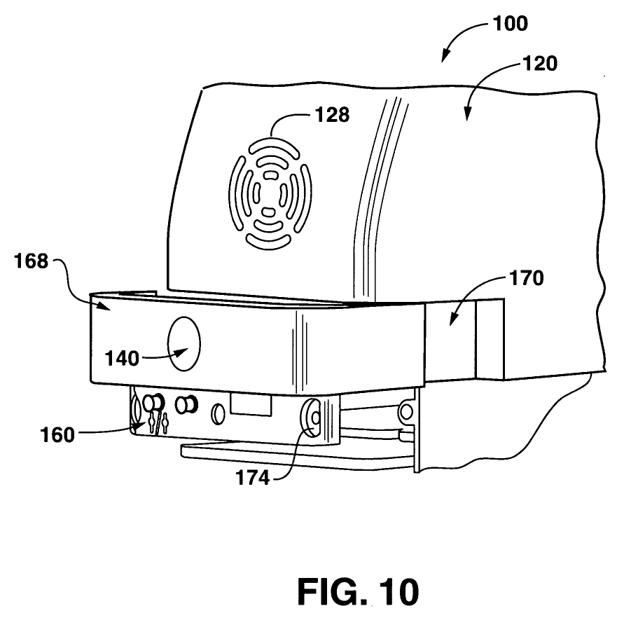

FIG. 10 illustrates an embodiment 100 wherein an electronics package 168 is removable from the housing 120. The electronics 168 may include essentially all or a substantial portion of the electronic operating components of the device 100, such as the audio playback device, message track storage device, control circuitry, and the like. The electronics package 168 is removably received in a receptacle 170 in the housing 120. The package 168 may slide into the housing 120 along any configuration of rails or guide structure. When inserted, the electronics package 168 is in electrical communication with the battery compartment and speaker within the housing 120. The speaker may also be a component of the electronics package 168. Mounting holes 174 may be provided to secure the package 168 relative to the housing 120 by, for example, bolts, screws, or other releasable type fasteners. Once inserted, the housing cover 124 is closed and prevents removal of the package 168.

The removable electronics package 168 may include an internal non-removable message storage device, such as a digital sound chip, flash memory, or the like. In this embodiment, the message tracks are programmed into the storage device prior to insertion of the electronics package 168 into the housing 120. In an alternative embodiment, the electronics package 168 may be configured for receipt of a removable storage device, such as a flash memory card as discussed above.

The ability to remove and replace the complete electronics package 168 may provide various benefits. In the event of a malfunction of the device, the electronics package 168 is readily removed and replaced with a substitute package, and it is not necessary to dismount and remove the complete device 100. An inventory of the electronics packages 168 may be maintained by a facility for a quick change-out of the packages when necessary. The packages 168 can be programmed or formatted by the manufacturer, or by the receiving facility at remote locations. Alternatively, the packages 168 may be programmed or reprogrammed even after installed into the device 100, depending on the particular type of audio playback device utilized.

As mentioned, the various devices 10, 100 according to the invention may utilize any number of commercially available audio playback devices. For example, Winbond Electronics Corporation of America of San Jose, Calif., supplies a number of suitable devices known as CHIPCORDER devices. These devices are single-chip devices designed for voice and audio recording and playback. The chips may be pre-recorded with a single or multiple message, or reprogrammed after being embedded in the system. Another company, Eletech of City of Industry, California, supplies a line of digital sound boards known as QUIKVOICE boards wherein any combination of sound files are stored in either EPROM chips or flash memory. The flash memory version offers the capability of changing the messages, while the EPROM models are recommended for applications where messages will rarely be changed. The sound segments can be activated by sensors, such as a motion sensor, or microcontrollers in response to an externally sensed condition. Eletech also supplies a line of digital sound chips that may be configured with a microprocessor and associated control circuitry for use in devices according to the invention.

It should be appreciated by those skilled in the art that various modifications and variations can be made to the embodiments of the device described herein without departing from the scope and spirit of the invention. It is intended that the invention include these and other modifications and variations as come within the scope of the appended claims and their equivalents.

What is claimed is:

1. A device to encourage hand washing compliance, comprising:
a housing configured for detachably mounting on a support surface;
a passive sensor disposed relative to said housing to detect a threshold condition adjacent said device;
a receptacle within said housing configured for receipt of a removable storage device that contains at least one hand wash compliance message track stored thereon;
an audio playback device within said housing that processes and plays said message track stored on said removable storage device in audible format over a speaker upon detection of the threshold condition by said sensor; and
wherein a plurality of said removable storage devices with different hand wash compliance message tracks are compatible with said playback device.

2. The device as in claim 1, further comprising at least one said removable storage device, wherein said removable storage device contains said message track in digital form.

3. The device as in claim 2, wherein said removable storage device comprises a memory card that is insertable into said receptacle within said housing.

4. The device as in claim 2, wherein said removable storage device contains a plurality of different message tracks.

5. The device as in claim 2, wherein said removable storage device is programmable with different or additional message tracks.

6. The device as in claim 1, wherein said device is battery powered, and further comprising control circuitry configured with said playback device and passive sensor, said control circuitry placing said playback device in a ready powered-up state upon detection of the threshold condition, and further comprising an additional sensor configured with said control circuitry that initiates playback of said message track upon detection of an additional sensed parameter near said device.

7. The device as in claim 6, wherein said passive sensor comprises an ambient light sensor, and said additional sensor comprises a passive sensor.

8. The device as in claim 7, wherein said additional sensor comprises an additional ambient light detector that senses changes in ambient light resulting from persons passing by or near said device.

9. The device as in claim 8, wherein said ambient light sensor is disposed to look out through said housing in a direction wherein ambient light is generally not be disrupted by persons near said device, and said additional ambient light sensor is disposed in a different direction to detect variations in ambient light caused by persons near said device.

10. The device as in claim 6, wherein said additional sensor comprises an active sensor.

11. The device as in claim 10, wherein said active sensor comprises an IR transmitter and receiver.

12. A battery powered device to encourage hand washing compliance, comprising:
a housing configured for detachably mounting on a support surface;
a battery compartment within said housing;
a self-contained electronics package further comprising a playback device, message storage device, and associated control circuitry, said electronics package removable from said housing;
a receptacle within said housing configured for receipt of said electronics package, when inserted into said receptacle said electronics package is in communication with said battery compartment; and
wherein said message storage device includes at least one hand wash compliance message track that is played by said playback device at a predetermined frequency.

13. The device as in claim 12, further comprising a speaker mounted within said housing, said electronics package in communication with said speaker when inserted into said receptacle.

14. The device as in claim 12, wherein said message storage device comprises an internal non-removable component of said electronics package.

15. The device as in claim 14, wherein said electronics package comprises an input port for externally programming said message track on said message storage device.

16. The device as in claim 12, wherein said message storage device is removable from said electronics package.

17. The device as in claim 12, wherein said electronics package further comprises a sensor that detects a threshold condition near said device prior to said control circuitry initiating playback of said message track.

18. The device as in claim 17, wherein said sensor comprises an ambient light sensor that detects a threshold amount of ambient light adjacent said device, said control circuitry initiating playback of said message track at a predetermined frequency with ambient light above the threshold value.

19. The device as in claim 17, wherein said sensor comprises an active sensor that detects the presence of individuals near said device.

20. The device as in claim 12, wherein said electronics package further comprises an externally accessible adjustment to vary dwell time between playback of said message track.

21. The device as in claim 12, wherein said housing comprises a removable front cover that prevents removal of said electronics package from said housing in a closed position of said cover.
